(19) United States
(12) Patent Application Publication
(10) Pub. No.: US 2007/0210224 A1
(43) Pub. Date: Sep. 13, 2007

(54) DISKDRIVE BRACKET MOUNTING STRUCTURE

(75) Inventor: Feng-Qing Su, TAIPEI (TW)

Correspondence Address: ADLINK TECHNOLOGY INC., P.O. BOX 108-00403, TAIPEI, TW

(73) Assignee: ADLINK TECHNOLOGY INC., Chungho City (TW)

(21) Appl. No.: 11/308,163

(22) Filed: Mar. 9, 2006

(51) Int. Cl. F16M 11/00

(52) U.S. Cl. 248/200

(57) ABSTRACT

A diskdrive bracket mounting structure includes a bracket, a hexagonal copper column set at the bottom side of the bracket, a master cushion mounted in a mounting through hole of the bracket and sandwiched between the bracket and the hexagonal copper column, a supplementary cushion supported on the top side of the bracket around a part of the master cushion, and a P-head screw inserted through a through hole of the supplementary cushion and a through hole of the master cushion and threaded into a screw hole of the hexagonal copper column to affix the bracket to the hexagonal copper column, allowing the diskdrive bracket mounting structure to provide both the function of classis ground as well as the function of digital ground.

### BACKGROUND OF THE INVENTION

1. Field of the Invention

The present invention relates to a diskdrive bracket mounting structure and more particularly, to an improved structure of diskdrive bracket mounting structure that provides both function of classis ground as well as the function of digital ground.

2. Description of the Related Art

Currently, many enterprises install relatively cheaper mini servers to satisfy network traffic requirements. In order to improve further economic effect, blade servers are developed. A blade server is a thin, modular electronic board, containing at least one microprocessor and memory that is intended for a single, dedicated application and that can be easily inserted into a rack with many similar servers.

A blade server machine case can accommodate several tends of blade servers or more, and blade server is equivalent to a regular server. These blade servers share the same resources such as server machine case, display, keyboard and power supply unit, achieving easy connection to the big scale data center. Further, the server machine case has installed therein an intelligent system that provides internal resource-related information. The intelligent system can discriminate webbed blade server resources, specific tasks, or application software run on the blade servers, allowing flexible application of every blade server in the server machine case. The most attractive advantage of a blade server is its high reliability and extendibility because every blade server has the backup function. The hot plugging of the server machine case that supports blade servers and system component parts provides high applicability. When one blade server failed, another blade server can take the place without interrupting the service. When wishing to increase the handling power, it needs only to insert more blade servers and to arrange these resources at the place where the demand is most strong.

In order to satisfy the demand for next generation communication equipment and the market demand for high traffic data bandwidth, server blades follow the modular design of Compact PCI specifications. The structural design includes the definition of the server machine case, the main board, the back board, the dimensions of the rear I/O extension board, the height limitation, the connector used, the front panel, the hot plugging handle, and etc. According to this new definition, the 8 U long space of the front face panel is sufficient for accommodating four standard PMC slots and four standard LED displays and can support the hot plugging function of the main board when used with a specific handle. However, a PMC module's user must accurate know the transmission way, interconnection between V (I/O) and rear I/O, and the compatibility of the supported bus arbitration to the carrier board. Further, the power demand for the interface of relatively higher speed and the expansion of next generation silicon circuit requires a change of PMC's specification. These drawbacks impart a barrier to the use of PMC module. Further, a blade server defines the hard diskdrive to be a part of digital ground. Further, when a hard diskdrive is installed in a blade server, it is exposed to the outside and not well protected. This arrangement does not provide an environment for quick dissipation of heat from the hard diskdrive. Therefore, the location and mounting arrangement of hard diskdrives in a server are quite important.

FIGS. 4 and 5 show a diskdrive bracket mounting structure according to the prior art. According to this design, a cushion A3 is set in between the top side of a hexagonal copper column A4 and the bottom side of the bracket A1 and partially inserted into a mounting through hole A11 at the bracket A1, and a screw A2 is inserted through a center through hole A31 of the cushion A3 and threaded into the hexagonal copper column A4 to affix the bracket A1 to the hexagonal copper column A4. This design of diskdrive bracket mounting structure is still not satisfactory in function. When fastened tight the screw A2, the cone of the head of the screw A2 imparts a high pressure to the cushion A3, causing the cushion A3 to deform permanently or to break. Further, if the user does not fasten tight the screw A2, the hexagonal copper column A4 may be biased relative to the bracket A1.

Therefore, it is desirable to provide a diskdrive bracket mounting structure that eliminates the aforesaid problems.

### SUMMARY OF THE INVENTION

The present invention has been accomplished under the circumstances in view. It is the main object of the present invention to provide a diskdrive bracket mounting structure, which provides both the function of classis ground as well as the function of digital ground. It is another object of the present invention to provide a diskdrive bracket mounting structure, which is practical for repeated use. It is still another object of the present invention to provide a diskdrive bracket mounting structure, which is inexpensive to manufacture and easy to install. To achieve these and other objects of the present invention, the diskdrive bracket mounting structure comprises a bracket, which has a mounting through hole, a hexagonal copper column, which is set at the bottom side of the mounting through hole of the bracket and has a screw hole, a master cushion, which is mounted in the mounting through hole of the bracket and sandwiched between the bracket and the hexagonal copper column and has a shank and a through hole; and a screw, which is inserted through the through hole of the master cushion and threaded into the screw hole of the hexagonal copper column to affix the bracket to the hexagonal copper column and has a head stopped above the master cushion; wherein a supplementary cushion is supported on the top side of the bracket opposite to the hexagonal copper column around the shank of the master cushion and sandwiched in between the head of the screw and the bracket. The master cushion and the supplementary cushion are respectively made out of an electrically insulative material. Further, the master cushion and the supplementary cushion prevent direct contact between the bracket and the hexagonal copper column.

### BRIEF DESCRIPTION OF THE DRAWINGS

FIG. 1 is an installed view of a diskdrive bracket mounting structure according to the present invention.

FIG. 2 is an exploded view of the diskdrive bracket mounting structure according to the present invention.

FIG. 3 is a sectional side view of the diskdrive bracket mounting structure according to the present invention.

FIG. 4 is an exploded view in section of a diskdrive bracket mounting structure according to the prior art.

FIG. 5 is an installed view in section of the prior art diskdrive bracket mounting structure.

### DETAILED DESCRIPTION OF THE PREFERRED EMBODIMENT

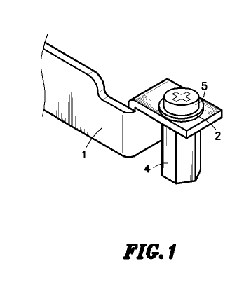

Referring to FIGS. 1˜3, a diskdrive bracket mounting structure in accordance with the present invention is shown comprising a bracket 1, a supplementary cushion 2, a master cushion 3, a hexagonal copper column 4, and a screw 5.

The bracket 1 has a mounting through hole 11.

The supplementary cushion 2 is made out of an electrically insulative material, having a through hole 21 corresponding to the mounting through hole 11 of the bracket 1.

The master cushion 3 is s made out of an electrically insulative material, having a shank 31 insertable through the mounting through hole 11 of the bracket 1 and a through hole 32 axially cut through two distal ends of the shank 31.

The hexagonal copper column 4 has a screw hole 41 extending through the two distal ends thereof.

The screw 5 is a P-head screw insertable through the through hole 21 of the supplementary cushion 2 and the through hole 32 of the master cushion 3 into the screw hole 41 of the hexagonal copper column 4.

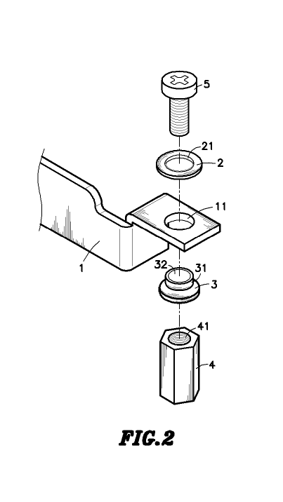

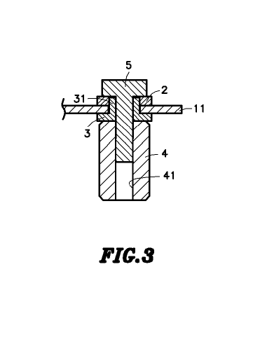

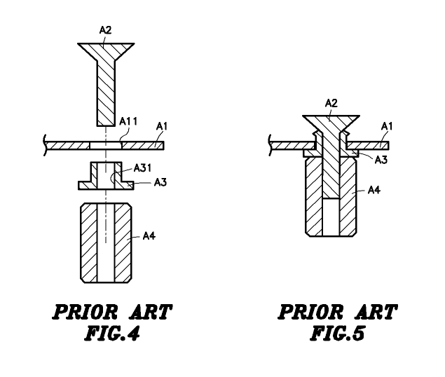

Referring to FIGS. 1 and 2 again, during installation, the supplementary cushion 2 is placed on the bracket 1 at the top side of the mounting through hole 11, and then the master cushion 3 is attached to the bracket 1 at the bottom side of the mounting through hole 11 to force the shank 31 into the mounting through hole 11 of the basket 1 and the through hole 21 of the supplementary cushion 2, and then the hexagonal copper column 4 is attached to the bottom side of the master cushion 3, and then the screw 5 is inserted through the through hole 21 of the supplementary cushion 2 and the through hole 32 of the master cushion 3 and threaded into the screw hole 41 of the hexagonal copper column 4. When the screw 5 and the hexagonal copper column 4 are fastened tight, the supplementary cushion 2 and the master cushion 3 are firmly secured to the bracket 1. However, because the master cushion 3 is stopped against the bottom wall of the bracket 1 and the shank 31 of the master cushion 3 is supported on the periphery of the mounting through hole 11 of the bracket 1 and the inner diameter of the supplementary cushion 2, fastening tight the screw 5 does not cause the master cushion 3 to break. When not in use or when changing the hard diskdrive, the screw 5 can be disconnected from the hexagonal copper column 4, and the parts of the diskdrive bracket mounting structure can be well received for a repeated use.

Further, because the supplementary cushion 2 and the master cushion 3 are electrically insulative and set to prevent direct contact between the bracket 1 and the hexagonal copper column 4, the diskdrive bracket mounting structure provides both the function of classis ground as well as the function of digital ground.

As indicated above, the invention provides a diskdrive bracket mounting structure, which has the following features.

1. The screw 5 is vertically downwardly inserted through the through hole 21 of the supplementary cushion 2 and the through hole 32 of the master cushion 3 and then accurately threaded into the screw hole 41 of the hexagonal copper column 4 to affix the bracket 1 to the hexagonal copper column 4. When not in use, the screw 5 can be directly disconnected from the hexagonal copper column 4, and the parts of the diskdrive bracket mounting structure can be received for a repeated use.

2. The master cushion 3 is attached to the bottom side of the bracket 1 to force the shank 31 into the mounting through hole 11 of the bracket 1 and the through hole 21 of the supplementary cushion 2, and then the hexagonal copper column 4 is attached to the bottom side of the master cushion 3, and then the screw 5 is inserted through the through hole 21 of the supplementary cushion 2 and the through hole 32 of the master cushion 3 and threaded into the screw hole 41 of the hexagonal copper column 4. When the screw 5 and the hexagonal copper column 4 are fastened tight, the master cushion 3 is firmly secured in position between the bracket 1 and the hexagonal copper column 4 without breaking.

3. The parts of the diskdrive bracket mounting structure are inexpensive to manufacture and easy to install.

4. The supplementary cushion 2 and the master cushion 3 prevent direct contact between the bracket 1 and the hexagonal copper column 4, therefore the diskdrive bracket mounting structure provides both the function of classis ground as well as the function of digital ground.

A prototype of diskdrive bracket mounting structure has been constructed with the features of FIGS. 1˜5. The diskdrive bracket mounting structure functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A diskdrive bracket mounting structure comprising:
a bracket, said bracket having a mounting through hole;
a hexagonal copper column set at a bottom side of the mounting through hole of said bracket, said hexagonal copper column having a screw hole;
a master cushion mounted in the mounting through hole of said bracket and sandwiched between said bracket and said hexagonal copper column, said master cushion having a shank insertable through the mounting through hole of the basket, and a center through hole; and
a screw inserted through the through hole of said master cushion and threaded into the screw hole of said hexagonal copper column to fasten said bracket to said hexagonal copper column, said screw having a head stopped above said master cushion;
wherein:
a supplementary cushion is supported on a top side of said bracket opposite to said hexagonal copper column around the shank of said master cushion and sandwiched in between the head of said screw and said bracket.

2. The diskdrive bracket mounting structure as claimed in claim 1, wherein said screw is a P-head screw.

3. The diskdrive bracket mounting structure as claimed in claim 1, wherein said supplementary cushion is made out of an electrically insulative material.

4. The diskdrive bracket mounting structure as claimed in claim 1, wherein said master cushion is made out of an electrically insulative material.
